(19) United States
(12) Patent Application Publication
(10) Pub. No.: US 2024/0054384 A1
(43) Pub. Date: Feb. 15, 2024

(54) OPERATION-BASED PARTITIONING OF A PARALLELIZABLE MACHINE LEARNING MODEL NETWORK ON ACCELERATOR HARDWARE

(71) Applicant: Meta Platforms, Inc., Menlo Park, CA (US)

(72) Inventors: Garret Ray Catron, Sunnyvale, CA (US); Man Wang, San Jose, CA (US); Nadathur Rajagopalan Satish, San Jose, CA (US); Michael Anderson, Menlo Park, CA (US); Ying Zhang, Palo Alto, CA (US); Bertrand Allen Maher, Newark, CA (US)

(21) Appl. No.: 16/945,679

(22) Filed: Jul. 31, 2020

(51) Int. Cl. G06N 20/00; G06F 9/52; G06F 9/50

(52) U.S. Cl. CPC G06N 20/00; G06F 9/52; G06F 9/5061

(57) ABSTRACT

A machine learning model network is analyzed to identify types of operations and dependencies associated with different portions of the machine learning model network, including by classifying at least a portion of the types of operations as being memory bandwidth intensive or compute intensive. The machine learning model network is partitioned across a plurality of different machine learning accelerator hardware units based at least in part on the analysis. Parallelization and pipelining of an execution of the machine learning model network is allowed based on the partitioning.

### BACKGROUND OF THE INVENTION

Machine learning accelerators (also referred to herein as artificial intelligence accelerators, machine learning accelerator hardware units, accelerators, etc.) are a class of specialized hardware accelerators or computer systems designed to accelerate artificial intelligence applications. Machine learning accelerators are able to run artificial intelligence applications more efficiently (e.g., faster and/or consuming less power) than general-purpose computing hardware, such as central processing units. Machine learning accelerators can be utilized for various artificial intelligence applications, including recommendation, image classification, object detection, semantic segmentation, speaker diarization, speech recognition, translation, sentiment analysis, gameplay, and other applications. Many applications involve machine learning model networks that exhibit parallelism. Thus, it would be beneficial to develop techniques to exploit parallelism in machine learning model networks to more efficiently execute the machine learning model networks.

### BRIEF DESCRIPTION OF THE DRAWINGS

Various embodiments of the invention are disclosed in the following detailed description and the accompanying drawings.

FIG. 1 is a block diagram illustrating an embodiment of a system with multiple machine learning accelerators.

FIG. 2A is a diagrammatic representation of at least a portion of an example machine learning model network.

FIG. 2B is a diagrammatic representation of an example partitioning of a machine learning model network.

FIG. 2C is a diagrammatic representation of an example execution timeline for a partitioned machine learning model network.

FIG. 3 is a flow chart illustrating an embodiment of a process for performing operation-based partitioning of a parallelizable machine learning model network on accelerator hardware.

FIG. 4 is a flow chart illustrating an embodiment of a process for assigning operators of a machine learning model network to different machine learning accelerator hardware units.

FIG. 5 is a flow chart illustrating an embodiment of a process for allowing parallel and pipelined execution of a machine learning model network.

FIG. 6 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A machine learning model network is analyzed to identify types of operations and dependencies associated with different portions of the machine learning model network, including by classifying at least a portion of the types of operations as being memory bandwidth intensive or compute intensive. The machine learning model network is partitioned across a plurality of different machine learning accelerator hardware units based at least in part on the analysis. Parallelization and pipelining of an execution of the machine learning model network is allowed based on the partitioning. A practical and technological benefit of the techniques disclosed herein is increased throughput of machine learning operations on machine learning accelerator hardware. Throughput is increased by performing operations in parallel, within each machine learning accelerator hardware unit as well as across different machine learning accelerator hardware units. In this manner, more operations can be performed within a specified period of time. A benefit of the techniques disclosed herein is improved performance for various machine learning applications that support performing operations in parallel, e.g., personalized recommendation (also referred to simply as recommendation). Prior approaches that do not exploit parallelism are not as computationally efficient.

Personalized recommendation is the task of recommending content to users based on their preferences and previous interactions. Personalized recommendation is a fundamental building block of many internet services used by search engines, social networks, online retail, and content streaming. Delivering accurate recommendations in a timely and efficient manner can be computationally demanding and challenging due to the large volume of data that needs to be processed to determine which recommendations to make. For example, with video ranking, a small number of videos, out of potentially millions, may need to be recommended to each user. In some embodiments, personalized recommendation systems are utilized to deliver personalized advertisements to users. Many personalized recommendation systems utilize machine learning to improve accuracy and deliver a better user experience. In terms of machine learning, this involves looking up comparatively small working sets (e.g., on the order of megabytes) in large embedding tables (also referred to as lookup tables) (e.g., on the order of tens to hundreds of gigabytes). These sparse lookup operations are also referred to as embedding operations. Results of embedding operations are referred to as embeddings, embedding vectors, etc.

Embedding operations typically exhibit gather-reduce patterns in which the specific element-wise reduction operation can vary. An example of an embedding operation is SparseLengthsSum (SLS), which includes a sparse lookup into a large embedding table followed by a summation of looked up elements. Another example of an embedding operation, is SparseLengthsWeightedSum8BitsRowwise, which is a variant in the SparseLengths family of embedding operations and performs a gather-reduce embedding operation with quantized, weighted summation. The SLS operator has low compute but higher memory requirements. Stated alternatively, sparse lookup is typically memory bandwidth intensive but not compute intensive. Thus, SLS and its variants can introduce memory performance bottlenecks.

Personalized recommendation systems utilize machine learning model networks (also referred to herein simply as networks) that usually include multiple phases. Typically, the first phase is sparse lookup (as described above). Once the embeddings are collected, the next phase is usually combination, which is typically compute intensive but not memory bandwidth intensive. The combination phase oftentimes involves performing a computation with a multilayer perceptron (MLP). An MLP refers to a class of feedforward artificial neural network, e.g., with multiple layers (such as an input layer, one or more hidden layers, and an output layer). MLPs utilize supervised learning techniques (e.g., backpropagation) for training. Techniques that partition the different phases of personalized recommendation machine learning model networks (e.g., sparse lookup and one or more MLP phases) into their own sub-networks would allow different phases to be loaded onto different machine learning accelerator hardware units more suited for each phase and/or loaded onto individual machine learning accelerator hardware units that are capable of running different phases in parallel.

A machine learning model network may be regarded as a directed graph, wherein nodes of the directed graph correspond to machine learning model operators. In various embodiments, machine learning model operators (also referred to simply as operators) compute an output given an appropriate number and types of inputs and parameters. For example, an operator can correspond to an SLS operation. An operator can also correspond to a matrix multiply operation using an input tensor, a weights matrix, and/or a bias vector. To improve latency in a machine learning model network, the machine learning model network can be partitioned into several parallel networks. Suppose a machine learning model network that includes nodes A-F where nodes flow A→B→C and D→E→F. If the machine learning model network is partitioned across two machine learning accelerator hardware units, then these two dependency chains can run independently, potentially halving latency. Spreading sparse lookups across multiple machine learning accelerator hardware units allows memory bandwidth to be expanded by a factor equal to the number of machine learning accelerator hardware units operating in parallel, which alleviates memory bottlenecks.

In various embodiments, in addition to partitioning a machine learning model network across multiple machine learning accelerator hardware units, concurrent execution within a single machine learning accelerator hardware unit is allowed. Parts of the machine learning model network that that can be executed concurrently can be identified and run in parallel on a machine learning accelerator hardware unit. For example, in some embodiments, a sparse lookup is executed concurrently with a combination operation by an MLP. Concurrent execution can improve computational performance by splitting a machine learning model network into a memory bandwidth intensive portion and a compute intensive portion that run in parallel and saturate both the memory bus and the compute unit on a machine learning accelerator hardware unit to achieve higher throughput.

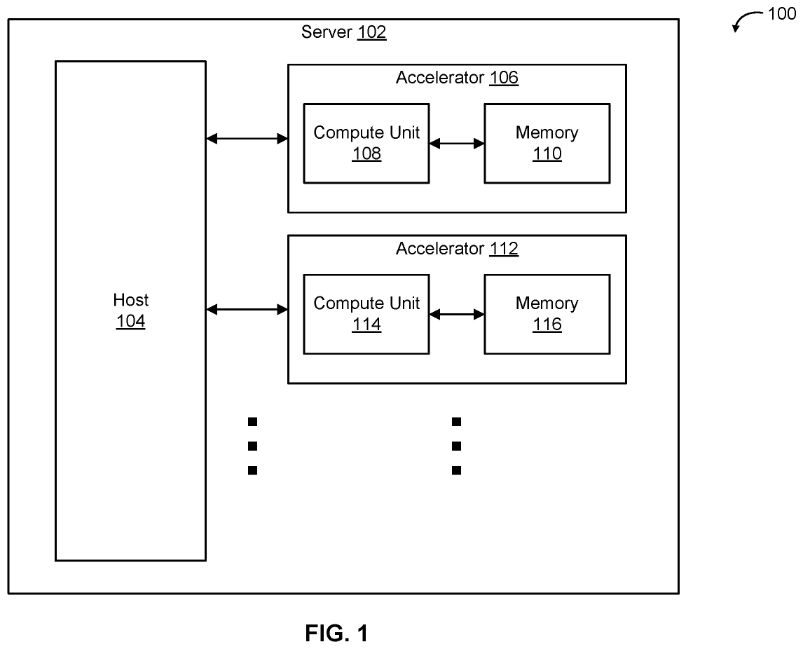

FIG. 1 is a block diagram illustrating an embodiment of a system with multiple machine learning accelerators. Machine learning accelerators are also referred to herein as machine learning accelerator hardware units, accelerators, etc. In the example shown, system 100 includes server 102. In various embodiments, server 102 is a computer or other hardware component that receives requests to perform machine learning/artificial intelligence related computations. In some embodiments, server 102 receives requests/data associated with machine learning/artificial intelligence related computations via a network. Examples of a network include one or more of the following: a direct or indirect physical communication connection, mobile communication network, Internet, intranet, Local Area Network, Wide Area Network, Storage Area Network, and any other form of connecting two or more systems, components, or storage devices together. Server 102 may receive a computer program compiled for one or more machine learning accelerators, receive input data associated with the compiled computer program, initiate an execution of an operation of the computer program, and return a result of the execution of the operation.

In the example shown, server 102 includes host 104 and accelerators 106 and 112. In the example shown, as indicated, more accelerators may also exist. In some embodiments, each accelerator is a specialized hardware unit designed to accelerate artificial intelligence applications. In the example shown, each accelerator has its own compute unit and memory (e.g., compute unit 108 and memory 110 of accelerator 106 and compute unit 114 and memory 116 of accelerator 112). In some embodiments, each accelerator utilizes a large slow memory (e.g., 16 gigabytes of a double data rate (DDR) based random-access memory (RAM)) and several smaller (but faster) caches closer to the compute unit. In the example shown, the accelerators are communicatively connected to host 104. In some embodiments, host 104 is a programmed computer system. In the example shown, host 104 is located on server 102. It is also possible for host 104 to be located on a server separate from but communicatively connected to server 102. In some embodiments, host 104 is configured to receive a computer program compiled for the accelerators, initiate an execution of the computer program, and cause data to be transferred to the accelerators. In some embodiments, host 104 executes a software runtime environment that receives the computer program. In some embodiments, host 104 includes a general-purpose digital processor that controls the operation of system 100. In some embodiments, host 104 loads a machine learning model network onto the accelerators of system 100. In some embodiments, host 104 partitions a machine learning model network across the accelerators of system 100 and/or assigns hardware resources of each accelerator (e.g., computing cores) to different operators of the machine learning model network.

In some embodiments, host 104 controls concurrent execution of operators on each accelerator. In some embodiments, host 104 runs a partitioning interface that handles low-level details associated with creating, compiling, and executing partition sub-networks. The partitioning interface may receive a small number of parameters, such as the number of partitions, partition-to-device mapping, and operator-to-partition mapping. Mapping may be determined programmatically by analyzing a graph associated with the machine learning model network.

In various embodiments, each accelerator receives input data. The input may be a tensor data object. The tensor can store various types of data. For example, for image recognition applications, the tensor may include image data (e.g., two-dimensional or three-dimensional images). The image data may also include color dimensions (e.g., red, green, and blue channels). The tensor may include multiple images in which the images are organized along a batch size dimension. As another example, for personalized recommendation applications, the tensor may include datasets to be searched (e.g., embedding tables). In some embodiments, the tensor data object is a container that includes a pointer to a raw data buffer storing data (e.g., image data, embedding table data, etc.) and also includes metadata associated with the data stored in the raw data buffer.

Input data may be received by a runtime environment (e.g., a software environment in which a computer program compiled for machine learning accelerator hardware is supported with access to software libraries, systems variables, environment variables, and other services and processes involved in the execution of a computer program). The runtime environment is the software environment in which the computer program is in a runtime state in which it can send instructions to accelerator hardware, access memory, and perform other runtime functions. In some embodiments, a device manager software component within the runtime environment handles transfer of input data to a specified machine learning accelerator (e.g., accelerator 106 or accelerator 112 in the example shown). In some embodiments, the device manager sets up direct memory access (DMA) transfers to send raw data (e.g., images, embedding tables, etc.) to the accelerator. DMA transfers can be utilized to transfer data across a peripheral component interconnect (PCI) bus system, such as PCI express (PCIe). In some embodiments, the device manager is responsible for copying data (e.g., tensor data) to the accelerator, initiating execution on the accelerator, and retrieving results from the accelerator.

In some embodiments, each accelerator receives data via a one-to-one relationship from a device manager. For a plurality of accelerators, there would be a matching plurality number of device managers. In some embodiments, a shared kernel mode driver interfaces with the one or more device managers in order for each device manager to communicate with its respective accelerator. Stated alternatively, in some embodiments, a plurality of device managers to one driver to a plurality of accelerators relationship exists. The driver generates transfer commands in a format that accelerators accept in response to data transfer instructions provided by a device manager. For example, in some embodiments, when a device manager provides DMA transfer instructions, the driver generates PCIe compatible transfer commands based on the DMA transfer instructions. Commands in other formats are also possible. The specific types of transfer commands generated by the driver depends on the communications architecture associated with the accelerators. In various embodiments, when an accelerator sends data back to the driver, the driver invokes routines in a device manager to accept the data from the accelerator.

In various embodiments, accelerators 106, 112, and any other accelerators on server 102 are configured to operate in inference mode, e.g., utilize a trained machine learning model to perform an artificial intelligence task, e.g., personalized recommendation. In various embodiments, each compute unit (e.g., compute unit 108 and/or compute unit 114) includes a plurality of computing cores (also referred to herein as cores, processing units, etc.). Compute units may also be configured to utilize low-precision arithmetic (e.g., half-precision and bfloat16 floating-point formats) and other architectural adaptations not included in general-purpose processors such as CPUs in order to increase computational throughput and/or reduce power consumption associated with machine learning inference computations. Various architectures may be used to implement the accelerators. An accelerator may include one or more graphics processing units (GPUs), application-specific integrated circuits (ASICs), or field-programmable gate arrays (FPGAs). Each accelerator may leverage a parallel computing architecture (e.g., at a matrix operation level) to increase computing throughput. In various embodiments, each memory (e.g., memory 110 and/or memory 116) includes various types of memory, e.g., a large slow memory (e.g., DDR-based) and smaller (but faster) caches closer to the compute unit. The memory stores various types of data (e.g., images, embedding tables, etc.) that the compute unit accesses to perform machine learning computations.

In the example shown, portions of the communication path between the components are shown. Other communication paths may exist, and the example of FIG. 1 has been simplified to illustrate the example clearly. Although single instances of components have been shown to simplify the diagram, additional instances of any of the components shown in FIG. 1 may exist. For example, more machine learning accelerator hardware units may exist. The number of components and the connections shown in FIG. 1 are merely illustrative. Components not shown in FIG. 1 may also exist.

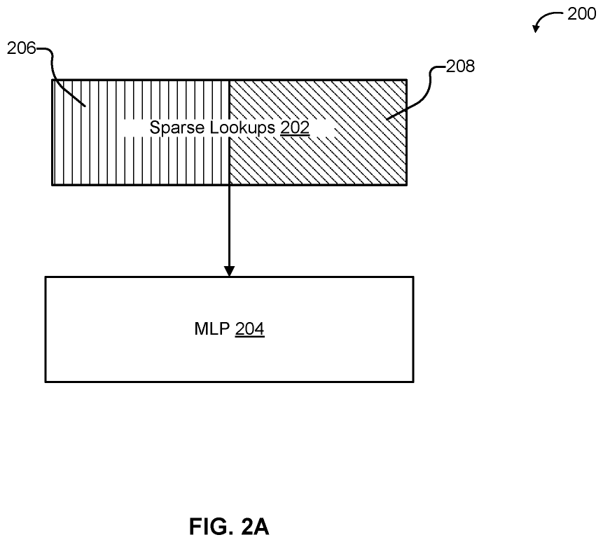

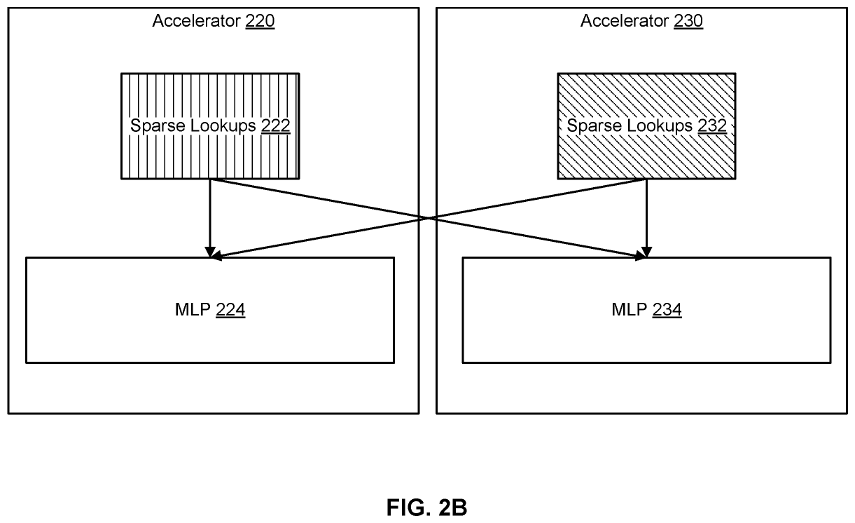

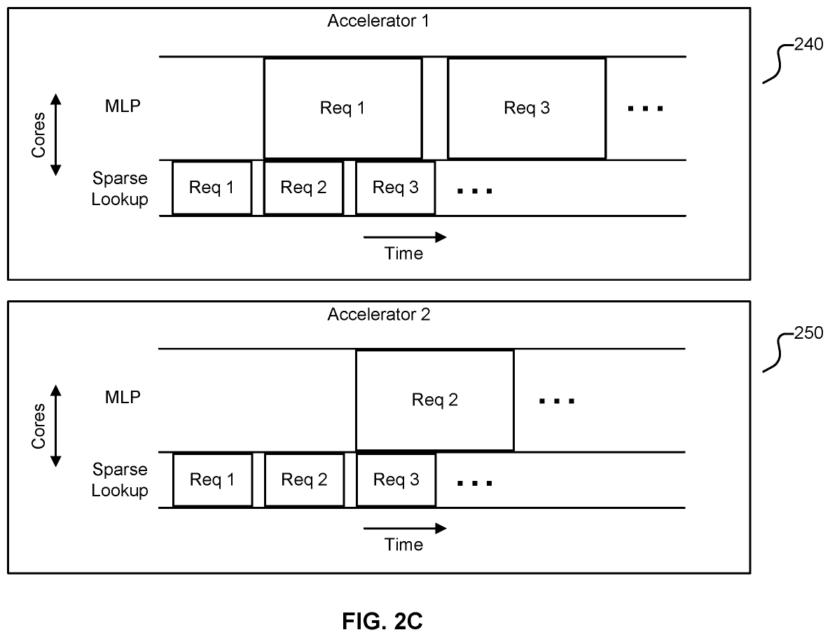

FIG. 2A is a diagrammatic representation of at least a portion of an example machine learning model network. In the example shown, machine learning model network 200 includes two portions: sparse lookups 202 and MLP 204. Other MLP portions (not shown) may also exist. In some embodiments, machine learning model network 200 runs on the accelerators of system 100 of FIG. 1. In the example shown, the sparse lookups 202 portion represents a group of sparse lookup operations that can execute immediately and the MLP 204 portion represents a combination phase utilizing an MLP that consumes the outputs of the sparse lookup operations and must wait to execute after the sparse lookups 202 portion. In various embodiments, these portions of machine learning model network 200 are compiled and pre-loaded onto machine learning accelerator hardware units (e.g., the accelerators of system 100 of FIG. 1), including embedding table data for the sparse lookups and weights for the MLP. The MLP combination phase may also use inputs from another portion of machine learning model network 200 (not shown) (e.g., another MLP portion that can be executed at the same time as the sparse lookups 202 portion). In various embodiments, general-purpose computer operations are performed (e.g., on host 104 of FIG. 1) prior to performing sparse lookup and MLP operations (e.g., in order to set up and initialize machine learning accelerator hardware). These operations occur before data is sent to the machine learning accelerators and is therefore the same regardless of how computations are partitioned on the accelerators.

The techniques disclosed herein solve several performance problems associated with running machine learning model network 200. First, embedding tables used in sparse lookups 202 may not fit into the memory of a single machine learning accelerator hardware unit, meaning machine learning model network 200 may not be able to be executed using a single machine learning accelerator hardware unit. Partitioning machine learning model network 200 across multiple machine learning accelerator hardware units (e.g., accelerators 106 and 108 of FIG. 1) addresses this problem. For example, portions 206 and 208 of sparse lookups 202 can be partitioned to accelerators 106 and 108 of FIG. 1 (e.g., embedding table data split up between memory 110 and memory 116 of FIG. 1). Second, even if machine learning model network 200 is small enough to fit within a single accelerator, there is a still a computational performance issue in that sparse lookups (tending to saturate memory bandwidth resources without significantly utilizing compute resources) and the MLP portion (tending to saturate compute resources without significantly utilizing memory bandwidth resources given that most of the MLP weights fit within on-chip memory) occur serially. This means that at any given time during execution of machine learning model network 200, either the memory is busy, or compute, but not both, leading to underutilization of hardware resources. As described in further detail herein, concurrent execution and pipelining address this problem. Third, with single accelerator execution, the MLP portion must find enough parallelism to saturate all the cores on the accelerator in order to achieve high efficiency, which may not always be possible. Such parallelism is not always easy to find and exploit. This problem is also addressed by concurrent execution and pipelining.

FIG. 2B is a diagrammatic representation of an example partitioning of a machine learning model network. In some embodiments, machine learning model network 200 of FIG. 2A is partitioned across the accelerators of FIG. 2B. In the example shown, a machine learning model network is partitioned across accelerators 220 and 230. In the example shown, sparse lookups 222 and MLP 224 are loaded onto accelerator 220 and sparse lookups 232 and MLP 234 are loaded onto accelerator 230. In some embodiments, sparse lookups 222 is portion 206 of sparse lookups 202 of FIG. 2A. In some embodiments, sparse lookups 232 is portion 208 of sparse lookups 202 of FIG. 2A. The machine learning model network may be divided into several sub-networks and loaded onto multiple accelerators because it is too large to run on a single accelerator. For example, embedding tables used in sparse lookups may not fit into the memory of a single accelerator. Sparse lookups 232 and 234 can be divided so as to balance embedding table sizes across accelerators. It is also possible to divide them so as to balance runtimes across partitions (requiring performance information associated with the sparse lookups, e.g., as done in profile-guided partitioning as described in further detail herein). Splitting the machine learning model network can improve performance via model parallelism.

In some embodiments, MLP 224 is MLP 204 of FIG. 2A. In some embodiments, MLP 234 is a duplicate of MLP 224. In some embodiments, a performance optimization pass is utilized by exchanging nodes among different partitions to optimize for total execution time. In various embodiments, a sub-network that is critical during execution is duplicated on different accelerators. In various embodiments, MLP 224 and MLP 234 are duplicates because the MLP sub-network is compute intensive and duplication reduces latency of a sequence of requests. The MLP partitions execute only after the sparse partitions are complete.

The example shown illustrate partitioning across two machine learning accelerator hardware units, but the techniques disclosed herein are not limited to using just two machine learning accelerator hardware units. For example, sparse lookups can be split across more than two accelerators (e.g., six accelerators) to further expand memory bandwidth and alleviate memory bottlenecks. Furthermore, models more complex than the one shown in FIG. 2A may be partitioned across accelerators. Regardless of model complexity, memory bandwidth intensive operations can be split across accelerators to alleviate memory bottlenecks and compute intensive operations can be duplicated on different accelerators to allow for pipelining (decreasing latency of a sequence of machine learning computation requests) and allow for more options for execution. With more complex models, additional partitions may be created to better fit the models into on-chip memory.

In various embodiments, each of accelerators 220 and 230 includes multiple computing cores to be allocated to different operators. In the example shown, for each accelerator, computing cores would be divided between sparse lookups and MLP computation. In the example shown, for each accelerator, a specified number of cores are allocated to sparse lookups and the rest to MLP computation. This split may be determined empirically through experimentation. In some embodiments, this split is determined based on a performance model that takes into account performance characteristics of operators and hardware resources.

In various embodiments, for the machine learning model network, operators are categorized as being either memory-bound (memory bandwidth intensive) or compute-bound (compute intensive). For machine learning model network 200 in FIG. 2A, sparse lookups are memory-bound and MLP computation is compute-bound. In some embodiments, detailed performance information for each operator (to categorize each operator) is based on collected data (e.g., by measuring data transfer times to determine how memory bandwidth intensive the operator is and compute times to determine how compute intensive the operator is). The collected data may be gathered by monitoring operators during inference runs. The collected data can be consolidated into a cost profile. After categorizing operators, hardware resources (e.g., number of cores) are determined. In some embodiments, hardware resources are determined based on hardware models for specific hardware units. Based on the operator performance information and hardware resources information, an allocation of cores can be determined.

For applications for which memory bandwidth is the performance bottleneck, in various embodiments, the number of cores needed to saturate the memory speed of an accelerator is determined, this number of cores is allocated to sparse lookups, and the rest of the cores on the accelerator are allocated to MLP computation. Personalized recommendation is typically memory bandwidth bound. The number of cores to saturate the memory speed of the accelerator can be determined accurately by knowing data transfer times associated with various operators and knowing memory performance characteristics of the accelerator. For applications for which computation is the performance bottleneck, cores would instead be first assigned to compute intensive operators and the rest of the cores would be assigned to memory intensive operators. Whether an artificial intelligence application (and its corresponding machine learning model network) has a memory or computation bottleneck may be determined based on analyzing a graph associated with the machine learning model network and performance characteristics of operators in the graph.

FIG. 2C is a diagrammatic representation of an example execution timeline for a partitioned machine learning model network. In some embodiments, the execution timeline shown corresponds to execution of machine learning model network 200 of FIG. 2A on accelerators 220 and 230 of FIG. 2B. Specifically, in some embodiments, timeline component 240 corresponds to accelerator 220 of FIG. 2B and timeline component 250 corresponds to accelerator 230 of FIG. 2B. Timeline components 240 and 250 are aligned with each other with respect to time (their horizontal axes). The example shown illustrates timing across two accelerators. This is merely illustrative and not restrictive. The timing analysis described here readily extends to scenarios involving partitioning of a machine learning model network across more than two accelerators.

The example shown illustrates three requests for machine learning model network computations (Reg1, Req2, and Req3). Each request has a sparse lookup portion and an MLP portion (divided amongst cores of each accelerator as shown on the vertical axes of timeline components 240 and 250). The sparse lookup portion for each request must complete execution before the corresponding MLP portion for that request can begin. In the example shown, Req1 has its sparse lookups execute in parallel across all the accelerators (Accelerator 1 and Accelerator 2 in the example shown) (on the cores allocated to sparse lookups). In some embodiments, splitting of sparse lookups of Req1 across two accelerators corresponds to execution of portions 206 and 208 of sparse lookups 202 of FIG. 2A in parallel on two different accelerators. After the sparse lookups of Req1 have completed, the MLP portion for Req1 can consume the outputs of the sparse lookups of Req1 and begin execution. In the example shown, the MLP portion for Req1 executes on Accelerator 1.

The MLP portion of each request can be handled by any accelerator because, in various embodiments, as shown in FIG. 2B, the MLP portion is duplicated across accelerators. Unlike the sparse lookups, the MLP portion for a single request is not parallelized across accelerators, but rather dealt in a round robin fashion across accelerators. Furthermore, at this point, sparse lookups for the next request (Req2) can begin (as illustrated in the example shown). The MLP portion for Req2 executes after the sparse lookups for Req2 have completed. In the example shown, the MLP portion for Req2 executes on Accelerator 2. It would not execute on Accelerator 1 because at this point, Accelerator 1 is still executing the MLP portion for Req1. Execution for Req3 and additional requests proceed in a similar manner. In the example shown, requests are pipelined to allow for higher throughput, which decreases latency for a sequence of requests. Parallelization of execution of the machine learning model network is allowed by splitting sparse lookups across accelerators. Pipelining of execution of the machine learning model network is allowed by duplicating the MLP portion of the machine learning model network on multiple accelerators. Stated alternatively, duplicating the MLP portion allows for concurrent execution. This allows for exploitation of coarse grain parallelism and prevents idle compute resources when a portion of a machine learning model network (e.g., sparse lookups) is not compute intensive enough to keep all cores of an accelerator occupied.

Even if a machine learning model network can fit onto a single accelerator, it can make sense to partition in the above manner in order to achieve simultaneous use of memory and compute resources. With a single accelerator, sparse lookups and MLP computation can be pipelined so that each MLP portion is executed after its corresponding sparse lookups portion. To allow for this, cores can be divided between sparse lookups and MLP computation. When the first request arrives, it is executed on the cores allocated to sparse lookups. When the sparse lookups are complete, the MLP portion of the first request can begin. At the same time, the second request's sparse lookups can also begin. At this point, the sparse lookups from the second request and the MLP portion of the first request can run concurrently. This utilizes both memory bandwidth and compute resources of a machine learning model accelerator hardware unit simultaneously.

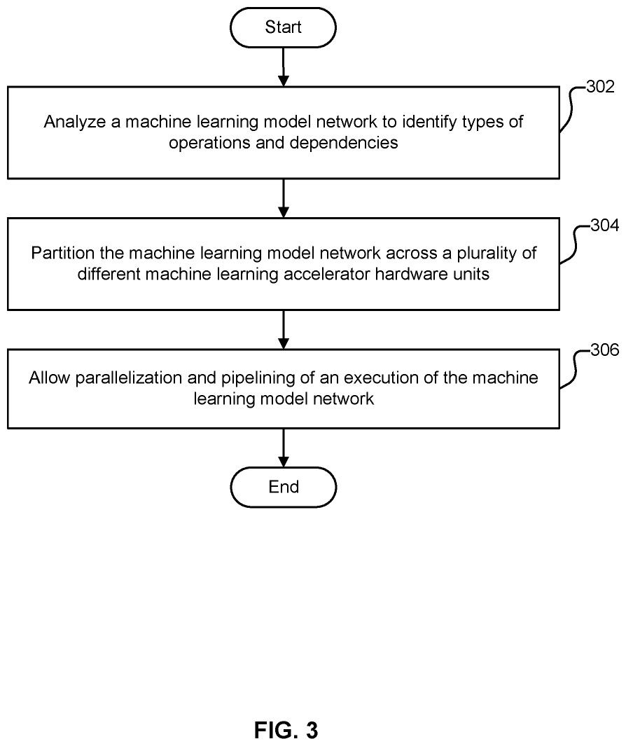

FIG. 3 is a flow chart illustrating an embodiment of a process for performing operation-based partitioning of a parallelizable machine learning model network on accelerator hardware. In some embodiments, the process of FIG. 3 is performed by server 102 of FIG. 1. For example, host 104 of FIG. 1 may direct partitioning of the machine learning model network across the accelerators of server 102.

At 302, a machine learning model network is analyzed to identify types of operations and dependencies. The operations and dependencies are associated with different portions of the machine learning model network. In some embodiments, a graph representing the machine learning model network is analyzed. In various embodiments, the nodes of the graph correspond to operations and connections between nodes correspond to dependencies. For example, FIG. 2A illustrates a graph that is at least a portion of a machine learning model network. Sparse lookups 202 and MLP 204 of FIG. 2A are operators performing operations (or just regarded as operations) that correspond to nodes. The connection between sparse lookups 202 and MLP 204 of FIG. 2A indicates a dependency in which MLP 204 executes after sparse lookups 202. In various embodiments, analyzing the machine learning model network includes classifying at least a portion of the types of operations as being memory bandwidth intensive or compute intensive. For example, sparse lookups 202 and MLP 204 of FIG. 2A would be classified as memory bandwidth intensive and compute intensive, respectively. This classification may be made based on performance data associated with the operators collected during inference executions of the machine learning model network. The classification may also be made based on operator type and/or machine learning model network type (e.g., by using a profiler loaded with prior information associated with operators and/or machine learning models).

At 304, the machine learning model network is partitioned across a plurality of different machine learning accelerator hardware units. In various embodiments, the partitioning is based at least in part on the analysis in 302. In some embodiments, at least a portion of the partitioning of the machine learning model network is performed manually. For example, a user may manually determine that sparse lookups 202 of machine learning model network 200 of FIG. 2A is to be split evenly across the different machine learning accelerator hardware units and MLP 204 is to be duplicated on all the different machine learning accelerator hardware units.

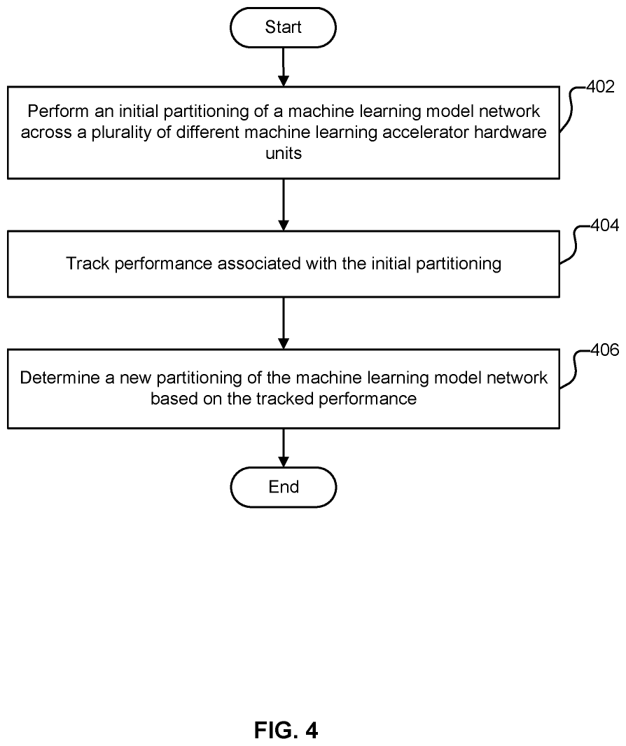

In some embodiments, a profile associated with partitioning of the machine learning model network across multiple machine learning accelerator hardware units is created based on measuring various parameters associated with the execution of the machine learning model network (e.g., computation times, data transfer times, and data sizes). In some embodiments, based on the profile, a new partitioning of the machine learning model network across the multiple machine learning accelerator hardware units is performed to improve performance (e.g., reduce computation times). Thus, the new partitioning is profile-guided (e.g., see FIG. 4). In some embodiments, partitioning is based on a cost model of operations and communication costs between accelerators. A machine learning model is run and data is collected. The partitioning is updated based on the collected data. The above process may be repeated several times to determine a satisfactory partitioning. In some embodiments, the profile (e.g., a cost profile) is also used as a predictive model upon which to base partitioning. For example, a profile created for a first collection of machine learning accelerator hardware units running a machine learning model network may be used or adapted to partition a second collection of machine learning accelerator hardware units running the same or a similar machine learning model network. The predictive model can be used to determine partitioning without collecting data on the machine learning model network as it runs.

At 306, parallelization and pipelining of an execution of the machine learning model network is allowed. In various embodiments, allowing parallelization and pipelining includes allocating computing cores of a machine learning accelerator hardware unit between different operators of the machine learning model network. For example, in a personalized recommendation machine learning model network, by assigning a first specified number of cores to sparse lookups and a second specified number of cores to MLP computation, sparse lookups can run in parallel across different machine learning accelerator hardware units and MLP computation can execute simultaneously with sparse lookups in a pipelined fashion (e.g., see FIG. 2C). Stated alternatively, concurrent execution of different portions of the machine learning model network is allowed.

FIG. 4 is a flow chart illustrating an embodiment of a process for assigning operators of a machine learning model network to different machine learning accelerator hardware units. In some embodiments, the process of FIG. 4 is performed by host 104 of FIG. 1. In some embodiments, at least a portion of the process of FIG. 4 is performed in 304 of FIG. 3.

At 402, an initial partitioning of a machine learning model network across a plurality of different machine learning accelerator hardware units is performed. In some embodiments, the machine learning model network includes a network of machine learning operators (e.g., sparse lookups, MLP, convolution, etc.). In various embodiments, the machine learning accelerator hardware units are specialized hardware (e.g., ASICs) configured to efficiently perform machine learning operator computations. In various embodiments, the initial partitioning performed at this point is a partitioning that does not take into account measured compute times, data transfer time, etc. of the operators. Thus, this initial partitioning may be improved upon through re-partitioning based on measured data. Examples of partitioning approaches include multi-level, spectral, eigenvalue, and other heuristics known in the art. In some embodiments, host 104 of FIG. 1 directs the partitioning.

At 404, performance associated with the initial partitioning is tracked. In various embodiments, the plurality of different machine learning accelerator hardware units is used to track costs associated with different portions of the machine learning model network. In various embodiments, compute time and data transfer time are costs that are tracked. In various embodiments, the different portions of the machine learning model network correspond to different machine learning operators of the machine learning model network. Thus, in various embodiments, compute times and data transfer times of the different machine learning operators of the machine learning model network are tracked by the plurality of different machine learning accelerator hardware units. Data may be tracked by utilizing counters and/or hardware clocks of the machine learning accelerator hardware units. Another cost that may be tracked is data size. The amount of data loaded into various partitions can be measured. In some embodiments, a cost function that incorporates several types of costs is utilized. In various embodiments, the costs are tracked during one or more inference executions of the machine learning model network. Stated alternatively, costs are tracked while a trained machine learning model is being utilized in inference mode, e.g., to make personalized recommendations, classify images, detect objects, recognize speech, process natural language data, or perform any other task for which the machine learning model is trained. Multiple samples are taken. Multiple samples (e.g., taken across multiple inference runs or multiple days of operation of the machine learning model) are valuable for more accurately determining costs (e.g., compute times and data transfer times of operators). Tracking costs by collecting actual data is valuable because many costs are difficult to predict without actual collected data. For example, compute times can be hardware dependent and difficult to predict until operators are run on the specific hardware.

At 406, a new partitioning of the machine learning model network is determined based on the tracked performance. For example, when tracked costs are based at least in part on compute time, the new partitioning may separate operators with long compute times into different partitions. If one partition is slow, some of its operators may be offloaded to another partition. In some embodiments, a profile that keeps track of operators and data sizes associated with partitions and corresponding performance outcomes is maintained. In some embodiments, compute times of operators are recorded and an objective function based at least in part on compute times of operators is formulated. The objective function may be formulated as a cost function to minimize to determine a distribution of operators across partitions that minimizes overall compute time. Because compute times of operators are hardware dependent, the compute times are measured again after operators have been moved to different partitions and another round of partitioning may be performed based on the next set of tracked costs. This process can be continued iteratively until specified conditions are met to indicate further re-partitioning would not significantly improve performance. Another approach is to perform this process iteratively a specified number of cycles.

In many scenarios, a machine learning model is in use for a relatively long period of time (e.g., months). During this time, weights used in the machine learning model may change but the model itself does not. New partitioning of the machine learning model may be performed when weights used in the machine learning model are updated. Stated alternatively, when weights change and the machine learning model is redeployed, there is an opportunity to adjust the partitioning. There is an opportunity to perform partitioning iteratively to continually refine the partitioning until a specified condition is met. For example, partitioning can be continued until the change in performance falls below a specified threshold, indicating additional re-partitioning will have marginal value in improving performance. Because machine learning models are in use for relatively long periods of time, benefits of better partitioning have a sustained, cumulative impact (over the periods of time that the machine learning models are in use) that can be very significant. In some embodiments, the new partitioning is performed using the same approach used for the initial partitioning (e.g., multi-level, spectral, eigenvalue, or another heuristic known in the art). In some embodiments, host 104 of FIG. 1 directs the new partitioning.

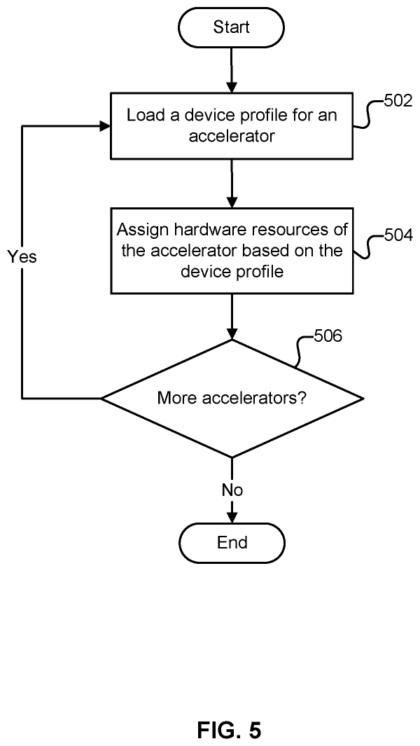

FIG. 5 is a flow chart illustrating an embodiment of a process for allowing parallel and pipelined execution of a machine learning model network. In some embodiments, the process of FIG. 5 is performed by server 102 of FIG. 1. In some embodiments, at least a portion of the process of FIG. 5 is performed in 306 of FIG. 3.

At 502, a device profile for an accelerator is loaded. In various embodiments, the device profile includes hardware characteristic of the accelerator that are utilized to determine how to assign hardware resources of the accelerator to various portions of the machine learning model network. In some embodiments, host 104 of FIG. 1 analyzes the loaded device profile.

At 504, hardware resources of the accelerator are assigned based on the device profile. For example, computing cores of the accelerator may be assigned. In some embodiments (e.g., for memory bandwidth bound applications), computing cores are assigned to memory intensive operations of the machine learning model network so as to saturate the memory bus of the accelerator. To determine how many computing cores are needed to saturate the memory bus, hardware information (e.g., memory speeds) of the accelerator and machine learning model information (e.g., data transfer times associated with operators) may be analyzed. Machine learning model information may be measured (e.g., in a profile-guided manner), predicted (e.g., by a profile), or obtained in some other manner. The remaining computing cores may then be assigned to compute intensive operations of the machine learning model network.

At 506, it is determined whether there are more accelerators that are running the machine learning model network. If at 506 it is determined that there are more accelerators, at 502, another device profile (specific to a different accelerator) is loaded. Hardware resources for that accelerator would then be assigned. If at 506 it is determined that there are no more accelerators for which to assign hardware resources, then no further action is taken.

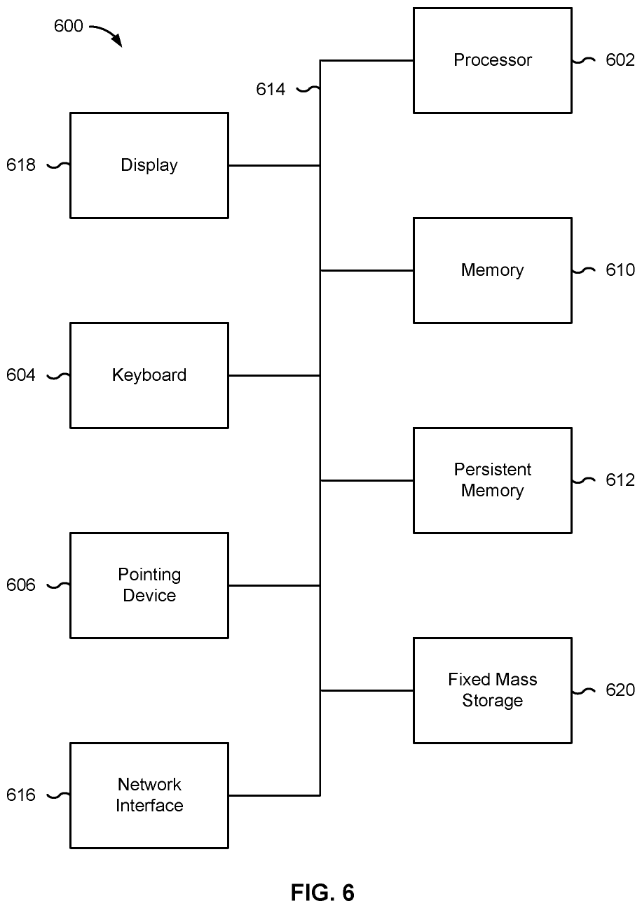

FIG. 6 is a functional diagram illustrating a programmed computer system. In some embodiments, the programmed computer system is host 104 of FIG. 1. In some embodiments, the programmed computer system directs partitioning of the accelerators of server 102 of FIG. 1.

In the example shown, computer system 600 includes various subsystems as described below. Computer system 600 includes at least one microprocessor subsystem (also referred to as a processor or a central processing unit (CPU)) 602. For example, processor 602 can be implemented by a single-chip processor or by multiple processors. In some embodiments, processor 602 is a general-purpose digital processor that controls the operation of computer system 600. Using instructions retrieved from memory 610, processor 602 controls the reception and manipulation of input data, and the output and display of data on output devices (e.g., display 618).

Processor 602 is coupled bi-directionally with memory 610, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also, as is well known in the art, primary storage typically includes basic operating instructions, program code, data, and objects used by processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

Persistent memory 612 (e.g., a removable mass storage device) provides additional data storage capacity for computer system 600, and is coupled either bi-directionally (read/write) or uni-directionally (read only) to processor 602. For example, persistent memory 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of fixed mass storage 620 is a hard disk drive. Persistent memory 612 and fixed mass storage 620 generally store additional programming instructions, data, and the like that typically are not in active use by processor 602. It will be appreciated that the information retained within persistent memory 612 and fixed mass storages 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, pointing device 606 can be a mouse, stylus, track ball, or tablet, and is useful for interacting with a graphical user interface.

Network interface 616 allows processor 602 to be coupled to another computer, computer network, or telecommunications network using a network connection as shown. For example, through network interface 616, processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect computer system 600 to an external network and transfer data according to standard protocols. Processes can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
analyzing a machine learning model network to identify types of operations and dependencies associated with different portions of the machine learning model network, including by classifying at least a portion of the types of operations as being memory bandwidth intensive or compute intensive;
partitioning the machine learning model network across a plurality of different machine learning accelerator hardware units based at least in part on the analysis; and
allowing parallelization and pipelining of an execution of the machine learning model network based on the partitioning.

2. The method of claim 1, wherein the machine learning model network is associated with personalized recommendation computations.

3. The method of claim 1, wherein at least a portion of the machine learning model network is associated with an embedding table lookup operation.

4. The method of claim 1, wherein at least a portion of the machine learning model network is associated with a combination operation that operates on embedding table lookup results.

5. The method of claim 1, wherein the types of operations classified as being compute intensive receive outputs of the types of operations classified as being memory bandwidth intensive.

6. The method of claim 1, wherein the machine learning model network includes a multilayer perceptron.

7. The method of claim 1, wherein the plurality of different machine learning accelerator hardware units includes one or more the following: an application-specific integrated circuit, a graphics processing unit, or a field-programmable gate array.

8. The method of claim 1, wherein each machine learning accelerator hardware unit of the plurality of different machine learning accelerator hardware units includes a compute unit and a memory unit.

9. The method of claim 8, wherein the compute unit include multiple computing cores.

10. The method of claim 1, wherein partitioning the machine learning network across the plurality of different machine learning accelerator hardware units includes partitioning the machine learning model network across a plurality of different processing units of the plurality of different machine learning accelerator hardware units.

11. The method of claim 1, wherein partitioning the machine learning model network across the plurality of different machine learning accelerator hardware units is based at least in part on costs associated with different portions of the machine learning model network that are tracked during one or more inference executions of the machine learning model network.

12. The method of claim 1, wherein allowing parallelization of the execution of the machine learning model network includes distributing a portion of the machine learning model network across multiple machine learning accelerator hardware units of the plurality of different machine learning accelerator hardware units.

13. The method of claim 12, wherein the distributed portion of the machine learning model network is memory bandwidth intensive.

14. The method of claim 1, wherein allowing pipelining of the execution of the machine learning model network includes duplicating a portion of the machine learning model network on multiple machine learning accelerator hardware units of the plurality of different machine learning accelerator hardware units.

15. The method of claim 14, wherein the duplicated portion of the machine learning model network is compute intensive.

16. The method of claim 1, wherein allowing pipelining of the execution of the machine learning model network includes concurrently executing a memory bandwidth intensive portion of the machine learning model network and a compute intensive portion of the machine learning model network on at least one machine learning accelerator hardware unit of the plurality of different machine learning accelerator hardware units.

17. The method of claim 1, wherein allowing pipelining of the execution of the machine learning model network includes allocating a first specified number of processing units of a machine learning accelerator hardware unit to a first portion of the machine learning model network and allocating a second specified number of processing units of the machine learning accelerator hardware unit to a second portion of the machine learning model network.

18. The method of claim 1, wherein the plurality of different machine learning accelerator hardware units is communicatively connected to a programmed computer system that directs partitioning of the machine learning model network across the plurality of different machine learning accelerator hardware units.

19. A system, comprising:
a plurality of different machine learning accelerator hardware units; and
one or more processors configured to:
analyze a machine learning model network to identify types of operations and dependencies associated with different portions of the machine learning model network, including by classifying at least a portion of the types of operations as being memory bandwidth intensive or compute intensive;
partition the machine learning model network across the plurality of different machine learning accelerator hardware units based at least in part on the analysis; and
allow parallelization and pipelining of an execution of the machine learning model network based on the partitioning.

20. A computer program product, the computer program product being embodied in a non-transitory computer readable storage medium and comprising computer instructions for:
analyzing a machine learning model network to identify types of operations and dependencies associated with different portions of the machine learning model network, including by classifying at least a portion of the types of operations as being memory bandwidth intensive or compute intensive;
partitioning the machine learning model network across a plurality of different machine learning accelerator hardware units based at least in part on the analysis; and
allowing parallelization and pipelining of an execution of the machine learning model network based on the partitioning.
